(19) United States
(12) Patent Application Publication
(10) Pub. No.: US 2026/0270092 A1
(43) Pub. Date: Sep. 10, 2026

(54) COMMUNICATION SYSTEM THAT REESTABLISHES CERTIFICATE-BASED TRUST USING CLIENT-SIDE VERIFICATION

(71) Applicant: VMware LLC, Palo Alto, CA (US)

(72) Inventors: Vardan Mikayelyan, Yerevan (AM); Vahram Aharonyan, Yerevan (AM)

(21) Appl. No.: 19/255,120

(22) Filed: Jun. 30, 2025

(30) Foreign Application Priority Data
Mar. 7, 2025 (AM) 20250016

(51) Int. Cl. H04L 9/32

(52) U.S. Cl. CPC H04L 9/3263; H04L 9/3247

(57) ABSTRACT

A client host is configured to reestablish certificate-based trust with a server host by performing the steps of: transmitting, to the server host, at least one certificate renewal request, and then receiving, from the server host, at least one certificate renewal response including a new digital certificate issued to the server host and a digital signature; locating, in a trust store in the client host, an old digital certificate that was issued to the server host before the new digital certificate, and decrypting the digital signature using an old public key in the old digital certificate; verifying that the new digital certificate was received from the server host based on the decrypted digital signature; and in response to verifying that the new digital certificate was received from the server host, establishing a secure channel with the server host and exchanging data with the server host over the secure channel.

### CROSS-REFERENCE TO RELATED APPLICATION

This application is based upon and claims the benefit of priority from Armenian Patent Application No. 20250016, filed Mar. 7, 2025, the entire contents of which are incorporated herein by reference.

### BACKGROUND

Computers often use digital certificates such as transport layer security (TLS) certificates to establish trusted connections that are backed by certificate-based trust. A digital certificate is an electronic document that proves the identity of an entity such as a website, and that facilitates encrypted communication with other entities. A digital certificate is “issued” to an entity, which means that the digital certificate has been generated for use by that entity for proving its identity. For example, a digital certificate may be issued by a certificate authority (CA) that verifies that an entity is legitimate before generating the digital certificate for that entity.

As used herein, a computer to which a digital certificate is issued and which communicates that digital certificate to other computers to prove its identity when transmitting responses to requests, is referred to as a “certificate holder,” “server host,” or “server.” Furthermore, as used herein, a computer that relies on the digital certificate for trusting the certificate holder when transmitting requests, is referred to as a “client host” or “client.” A digital certificate includes a cryptographic key of the certificate holder that is freely communicated to clients, referred to as a “public key.” A digital certificate further includes other information such as identifying information about the certificate holder. A digital certificate also corresponds to another cryptographic key that is stored securely by the certificate holder but not communicated to clients, referred to as a “private key.”

A certificate holder may update its digital certificate periodically to mitigate dangers such as the certificate holder’s private key being compromised. For example, each digital certificate may have a validity period such as 1 year. Each time the end of such period is approaching, a certificate holder may acquire a new digital certificate, e.g., from a CA that issued a previous digital certificate. Once a certificate holder updates its digital certificate, the certificate holder may drop any sessions it has with clients, and the certificate holder will no longer use the previous digital certificate for proving its identity. The certificate holder also deletes the private key corresponding to the previous digital certificate, which the certificate holder previously used with the previous digital certificate for proving its identity.

Accordingly, each time the certificate holder updates its digital certificate, the certificate holder must reestablish certificate-based trust with each client that relied on the previous digital certificate for secure communications. In other words, each client must acquire the new digital certificate from the certificate holder to secure future communications. Furthermore, each client must acquire the new digital certificate in a manner that guarantees that the new digital certificate is associated with the certificate holder. An efficient system for reestablishing such certificate-based trust is desired.

### SUMMARY

One or more embodiments provide a client host including a processor and memory, wherein the processor executes instructions stored in the memory to reestablish certificate-based trust between the client host and a server host. By executing such instructions, the client host performs the steps of: transmitting, to the server host, at least one certificate renewal request, and then receiving, from the server host, at least one certificate renewal response including a new digital certificate issued to the server host and a digital signature; locating, in a trust store in the client host, an old digital certificate that was issued to the server host before the new digital certificate but that is no longer used by the server host for proving the server host’s identity, and decrypting the digital signature using an old public key in the old digital certificate; and verifying that the new digital certificate was received from the server host based on the decrypted digital signature. Additionally, the steps further include performing the following in response to verifying that the new digital certificate was received from the server host: storing the new digital certificate in the trust store; and establishing a secure channel with the server host and exchanging data with the server host over the secure channel.

Further embodiments include a method comprising the above steps and a non-transitory computer-readable storage medium comprising instructions that cause a client host to carry out the above steps.

### BRIEF DESCRIPTION OF THE DRAWINGS

FIG. 1 is a block diagram of a computer system in which embodiments may be implemented.

FIG. 2 is a block diagram of an example of a certificate renewal package that may be used by embodiments for reestablishing certificate-based trust.

FIG. 3 is a flow diagram of a method that may be performed by a client host of the computer system to reestablish certificate-based trust with a server host of the computer system based on one new digital certificate, according to embodiments.

FIG. 4 is a flow diagram of a method that may be performed by the server host to reestablish certificate-based trust with the client host based on one new digital certificate, according to embodiments.

FIG. 5 is a flow diagram of a method that may be performed by the client host to reestablish certificate-based trust with the server host based on multiple new digital certificates, according to embodiments.

FIG. 6 is a flow diagram of a method that may be performed by the server host to reestablish certificate-based trust with the client host based on multiple new digital certificates, according to embodiments.

### DETAILED DESCRIPTION

Techniques are described for reestablishing certificate-based trust between a client and a server. According to techniques, when the server acquires a new digital certificate, e.g., from a CA, the server may generate an entity for storing the new digital certificate alongside other fields. The entity storing the new digital certificate and other fields is referred to herein as a “certificate renewal package.” For example, the server may generate a token or a data structure as the certificate renewal package. A “token” is a software entity such as a JavaScript Object Notation (JSON) web token (JWT) that stores data in a manner that is suitable for operations such as secure data transmission and authentication. A “data structure” is a software entity such as an array that stores data in an organized manner that enables a computer to efficiently access or modify the data.

The certificate renewal package may include the new digital certificate therein. The certificate renewal package may also include additional information that may be verified by the client to determine that the new digital certificate can be trusted. For example, such additional information may include a digital signature, which is a cryptographic value generated by encrypting data or encrypting a hash of that data using a private key. In particular, the certificate renewal package may include a digital signature that was generated using a private key corresponding to a previous digital certificate issued to the server, i.e., before the new digital certificate. After generating the digital signature, the server deletes the private key corresponding to the previous digital certificate because the server will no longer use the previous digital certificate and corresponding private key for proving its identity.

Upon the client encountering an exception in which the client is unable to verify the server’s new digital certificate, the client may begin handling of the exception by requesting the server for the certificate renewal package. In response, the server may transmit the certificate renewal package to the client, including the new digital certificate and the additional information. The client may then perform a client-side verification process using the certificate renewal package. Such verification process allows the client to determine that the certificate renewal package (and the new digital certificate therein) were indeed received from the server. In particular, if the client possesses the previous digital certificate, the client may use the public key therefrom to verify that the certificate renewal package (and the new digital certificate therein) are trusted. The client may then store the new digital certificate, which is extracted from the certificate renewal package, in a trust store. A trust store is a collection of digital certificates that are deemed to be trusted.

Certificate-based trust may thus be reestablished with minimal computation and communication between the client and server. For example, a lightweight token such as a JWT may be used as the certificate renewal package, a JWT being known for being compact and including minimal overhead metadata. Accordingly, the amount of data communicated between the client and server for reestablishing certificate-based trust may be minimized. Furthermore, a JWT may be safely transmitted as part of a uniform resource locator (URL) without causing issues with URL encoding, i.e., a JWT is “URL safe.” Accordingly, a server may transmit a JWT to a client upon the client’s request, e.g., using hypertext transfer protocol (HTTP) or HTTP secure (HTTPS).

In some situations, the server may have updated its digital certificate multiple times since the last secure communication with the client, e.g., because the client has been powered off for an extended period of time. In such case, the server may transmit multiple certificate renewal packages to the client, each including a digital certificate and including a digital signature generated using a private key corresponding to a previous digital certificate. The client may then perform a sequence of verifications on the certificate renewal packages from the oldest certificate renewal package to the newest. The client may start by using a public key from a digital certificate in its trust store to verify the oldest certificate renewal package, then add a digital certificate from the verified certificate renewal package to its trust store, then use a public key from the added digital certificate to verify a next certificate renewal package, and so on. The client may perform such sequence to move chronologically from a digital certificate that it originally possesses, to the newest digital certificate issued to the server. Accordingly, certificate-based trust may be reestablished with minimal computation and communication, even if the client is behind by multiple digital certificates.

Furthermore, according to embodiments, regardless of whether the client requires only one certificate renewal package for reestablishing certificate-based trust or requires multiple, the client is able to avoid dropping a request made to the server, e.g. a request for pushing client data to the server or acquiring resource data from the server. Instead, once the client verifies the server’s identity using one or more certificate renewal packages, the client may proceed with completing its request. In other words, once the client handles the exception from previously being unable to verify the server’s newest digital certificate, the client may determine that identity verification is successful and may proceed, e.g., without initiating a new request for pushing the client data or acquiring the resource data. These and further aspects of the invention are discussed below with respect to the drawings.

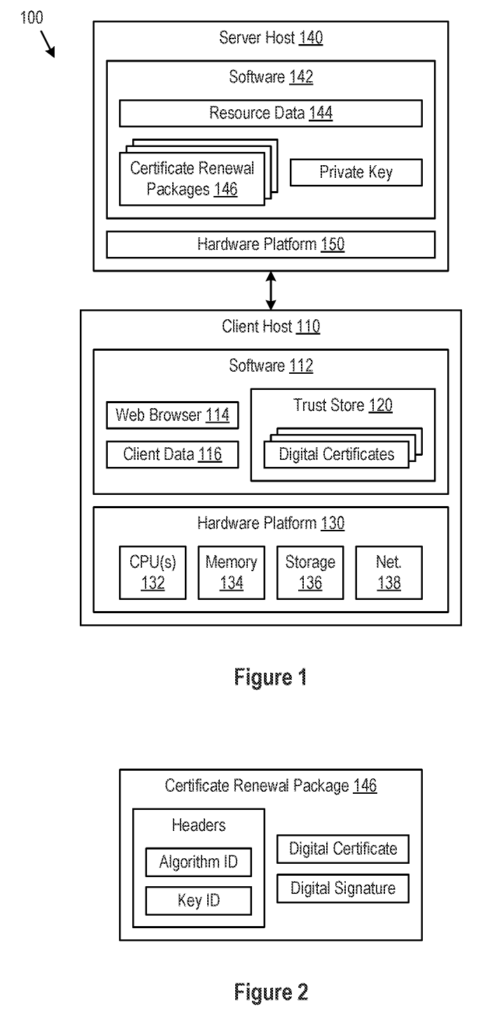

FIG. 1 is a block diagram of a computer system 100 in which embodiments may be implemented. Computer system 100 includes a client host 110 and a server host 140. Digital certificates are issued to server host 140, e.g., by a CA (not shown), and server host 140 uses the digital certificates for proving its identity to clients such as client host 110. For example, server host 140 may be a computer such as a server computer hosting a website. For example, client host 110 may be a computer such as a desktop computer, laptop computer, tablet computer, or smartphone accessing the website.

Client host 110 is constructed on a hardware platform 130. Hardware platform 130 includes components of a computer, such as one or more central processing units (CPUs) 132, memory 134 such as random-access memory (RAM), local storage 136 such as one or more magnetic drives or solid-state drives (SSDs), and networking hardware 138 such as one or more network interface controllers (NICs). CPU(s) 132 are configured to execute instructions such as executable instructions that perform one or more operations described herein, which may be stored in memory 134. Client host 110 may communicate with other devices such as server host 140 over a network such as the Internet.

Hardware platform 130 supports software 112. Software 112 may include a web browser 114 for accessing websites such as a website hosted by server host 140. Software 112 may also include an application (not shown) separate from web browser 114 for accessing websites. Software 112 further includes client data 116 that may be securely pushed to server host 140. For example, client data 116 may include public or private information of a user of client host 110 that is associated with a website hosted by server host 140. Software 112 further includes a trust store 120 for storing digital certificates, including a digital certificate issued to server host 140. Although illustrated as being separate, trust store 120 may be a part of web browser 114, i.e., trust store 120 may be maintained and used by web browser 114 for secure communications.

Server host 140 is constructed on a hardware platform 150. Hardware platform 150 includes components of a computer (not shown), such as one or more CPUs, memory such as RAM, local storage such as one or more magnetic drives or SSDs, and networking hardware such as one or more NICs. The CPU(s) of hardware platform 150 are configured to execute instructions such as executable instructions that perform one or more operations described herein, which may be stored in the memory of hardware platform 150. Server host 140 may communicate with other devices such as client host 110 over a network such as the Internet.

Hardware platform 150 supports software 142. Software 142 includes resource data 144 that may be securely accessed by client host 110. For example, resource data 144 may include public or private information associated with a website hosted by server host 140. Software 142 further includes certificate renewal packages 146, which are entities such as tokens (e.g., JWTs) or data structures used for reestablishing certificate-based trust with clients such as client host 110. Server host 140 further includes a private key corresponding to the newest digital certificate issued to server host 140, the newest digital certificate being stored in one of certificate renewal packages 146. Server host 140 deletes private keys corresponding to previous digital certificates, as discussed further below.

FIG. 2 is a block diagram of an example of one of certificate renewal packages 146 that may be used by embodiments for reestablishing certificate-based trust. As used in conjunction with FIG. 2, a digital certificate included in certificate renewal package 146 is referred to as a “new digital certificate,” and a digital certificate issued to server host 140 directly before the new digital certificate is referred to as a “previous digital certificate.” In the example of FIG. 2, server host 140 generates certificate renewal package 146 to include three fields: a headers field, a digital certificate field, and a digital signature field. In the headers field, server host 140 includes an algorithm identifier (ID), which may be an ID for a signing algorithm used for generating a digital signature. For example, the algorithm ID may identify a Rivest-Shamir-Adleman (RSA) signing algorithm such as RS512 or RS384. In the headers field, server host 140 may also include a key ID, which is an ID corresponding to the previous digital certificate. Server host 140 may include the key ID so that when client host 110 receives certificate renewal package 146, client host 110 may quickly locate the previous digital certificate, as discussed further below.

In the digital certificate field, server host 140 includes the new digital certificate, and in the digital signature field, server host 140 includes the digital signature. Server host 140 may generate the digital signature by applying the signing algorithm to certificate renewal package 146, i.e., to the headers field and digital certificate field. It should be noted that when applying the signing algorithm, server host 140 uses a private key corresponding to the previous digital certificate, i.e., not a private key corresponding to the new digital certificate. Accordingly, if client host 110 receives certificate renewal package 146 and client host 110 possesses the previous digital certificate, client host 110 may use a public key therein to verify the digital signature, as discussed further below. Server host 140 deletes the private key corresponding to the previous digital certificate after generating the digital signature for certificate renewal package 146 because server host 140 will no longer use the previous digital certificate and corresponding private key for proving its identity.

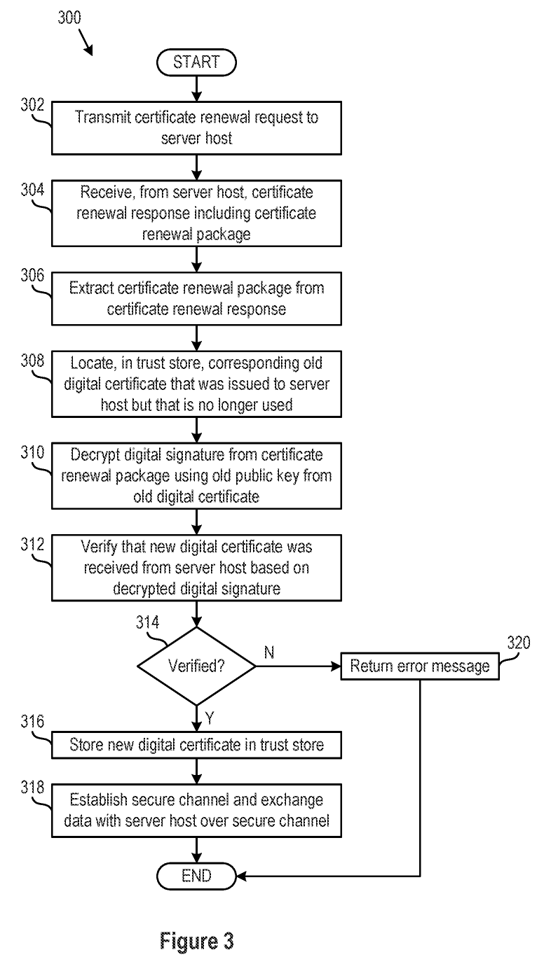

FIG. 3 is a flow diagram of a method 300 that may be performed by client host 110 to reestablish certificate-based trust with server host 140 based on one new digital certificate, according to embodiments. Method 300 may be performed by client host 110 when client host 110 is only behind by one digital certificate, i.e., when server host 140 has only updated its digital certificate once since a digital certificate possessed by client host 110. For example, client host 110 may initiate a “handshake” as part of establishing a secure channel with server host 140 for exchanging data such as for pushing client data 116 to server host 140 or for requesting resource data 144. A secure channel is a communication pathway between two entities over a network, that uses an encryption protocol such as TLS relying on one or more digital certificates. As used herein, “exchanging data” may refer to one-way communication of data between computers or to two-way communication of data between the computers.

Upon encountering an error (i.e., exception) in performing the handshake, client host 110 may initiate method 300 to handle the exception. In particular, client host 110 may transmit a “handshake request” to server host 140. Server host 140 may then transmit a “handshake response” to client host 110 including an unidentified digital certificate, i.e., including a digital certificate that client host 110 does not recognize. Upon determining that the unidentified digital certificate is not stored in trust store 120, client host 110 may initiate method 300 for handling the exception. As used herein, a handshake request is a message that requests server host 140 to identify itself using its current (newest) digital certificate, the handshake request being sent, e.g., based on the TLS protocol. A handshake response is a message that is sent in response to a handshake request and that includes the current digital certificate of server host 140, the handshake response being sent e.g., based on the TLS protocol.

At step 302, client host 110 transmits a “certificate renewal request” to server host 140. As used herein, a certificate renewal request is a message that requests server host 140 to provide at least one new digital certificate for reestablishing certificate-based trust, e.g., in one or more of certificate renewal packages 146. For example, web browser 114 may generate and transmit the certificate renewal request as an HTTP request. As another example, web browser 114 may generate the certificate renewal request as an HTTPS request with digital certificate verification of server host 140 disabled. Digital certificate verification may be disabled so that client host 110 may acquire one of certificate renewal packages 146 from server host 140 for verifying the identity of server host 140 thereafter.

At step 304, client host 110 receives, from server host 140 a “certificate renewal response” including one of certificate renewal packages 146. As used herein, a certificate renewal response is a message that is sent in response to a certificate renewal request and that includes at least one new digital certificate for reestablishing certificate-based trust, e.g., in one or more of certificate renewal packages 146. For example, web browser 114 may receive the certificate renewal response as an HTTP response or an HTTPS response. As mentioned previously, client host 110 may receive the certificate renewal response without verifying the identity of server host 140.

At step 306, client host 110 extracts certificate renewal package 146 from the certificate renewal response, including, e.g., a headers field with an algorithm ID and key ID, a digital certificate field including a new digital certificate, and a digital signature field including a digital signature. At step 308, client host 110 locates, in trust store 120, an old digital certificate that was issued to server host 140 but is no longer used by server host 140 for proving its identity, i.e., the digital certificate issued to server host 140 immediately before the new digital certificate. For example, the old digital certificate may correspond to the key ID. Accordingly, client host 110 may locate the old digital certificate by matching the key ID to a key ID in trust store 120.

At step 310, client host 110 decrypts the digital signature extracted from the certificate renewal response. Client host 110 decrypts the digital signature using an old public key from the old digital certificate located at step 308. Furthermore, client host 110 may identify a signing algorithm from the headers field. To decrypt the digital signature, client host 110 may apply a verification algorithm corresponding to the identified signing algorithm, the old public key being a parameter of the verification algorithm.

At step 312, client host 110 verifies that the new digital certificate was received from server host 140 based on the decrypted digital signature. For example, the signing algorithm may include a “hash function,” which is a deterministic function that produces a fixed-size string of characters, referred to as a “hash value.” Examples of hash functions include, e.g., secure hash algorithms (SHAs) such as SHA-512, which is used by RS512, and SHA-384, which is used by RS384. In such case, client host 110 may generate a hash value using the hash function included by the signing algorithm.

Specifically, client host 110 may input certificate renewal package 146 into the hash function, i.e., the headers and digital certificate fields thereof, to generate the hash value. Client host 110 may then compare the hash value to the decrypted digital signature. If they match, client host 110 may determine that it has successfully verified that the new digital certificate was received from server host 140. Otherwise, if they do not match, client host 110 may determine that it has not verified that the new digital certificate was received from server host 140.

As another example, the signing algorithm may not include a hash function at all. In such case, client host 110 may simply compare certificate renewal package 146, e.g., the headers and digital certificate fields thereof, to the decrypted digital signature. If they match, client host 110 may determine that it has successfully verified that the new digital certificate was received from server host 140. Otherwise, if they do not match, client host 110 may determine that it has not verified that the new digital certificate was received from server host 140.

At step 314, if the verification was successful, method 300 moves to step 316. At step 316, client host 110 stores the new digital certificate in trust store 120. Client host 110 may also delete the old digital certificate from trust store 120. At step 318, client host 110 establishes the secure channel with server host 140, e.g., according to the TLS protocol. Client host 110 then exchanges data with server host 140 over the secure channel, e.g., pushing client data 116 to server host 140 and/or acquiring resource data 144 from server host 140. After step 318, method 300 ends.

Returning to step 314, if the verification was not successful, method 300 moves to step 320. At step 320, client host 110 returns an error message indicating that client host 110 cannot verify a digital certificate issued to server host 140. For example, client host 110 may illustrate the error message on a graphical user interface (GUI) of client host 110. After step 320, method 300 ends.

It should be noted that after method 300, if client host 110 successfully established the secure channel with server host 140, future handshake requests with server host 140 will succeed as long as server host 140 continues using the same digital certificate for identifying itself. In other words, the next time client host 110 initiates a handshake request as part establishing a secure channel, client host 110 will not encounter an exception that requires handling according to the steps of method 300. It should also be noted that although not illustrated in FIG. 3, if client host 110 is unable to locate the old digital certificate corresponding to certificate renewal package 146 received from server host 140 at step 308, client host 110 returns an error message indicating that reestablishment of certificate-based trust could not be completed.

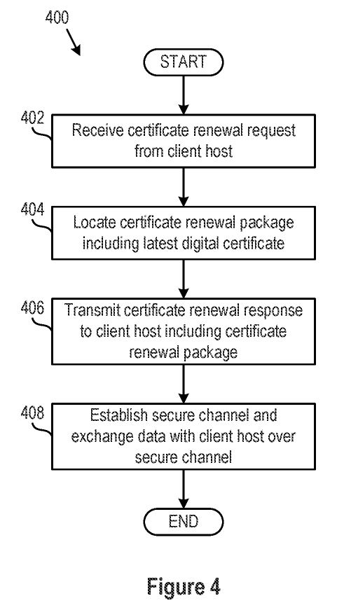

FIG. 4 is a flow diagram of a method 400 that may be performed by server host 140 to reestablish certificate-based trust with client host 110 based on one new digital certificate, according to embodiments. Method 400 may be performed by server host 140 when client host 110 is only behind by one digital certificate. At step 402, server host 140 receives a certificate renewal request from client host 110. At step 404, server host 140 locates one of certificate renewal packages 146, specifically one of certificate renewal packages 146 including the newest digital certificate issued to server host 140.

At step 406, server host 140 transmits a certificate renewal response to client host 110 including certificate renewal package 146. At step 408, assuming that client host 110 has successfully verified that the new digital certificate was received from server host 140, server host 140 establishes the secure channel with client host 110, e.g., according to the TLS protocol. Server host 140 then exchanges data with client host 110 over the secure channel, e.g., acquiring client data 116 from client host 110 and/or pushing resource data 144 to client host 110. After step 408, method 400 ends.

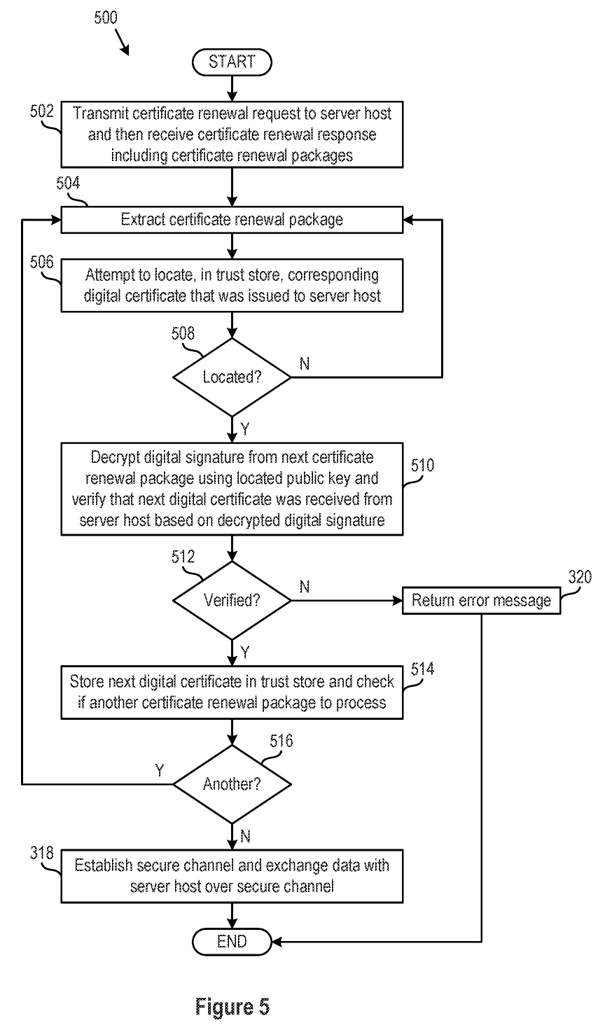

FIG. 5 is a flow diagram of a method 500 that may be performed by client host 110 to reestablish certificate-based trust with server host 140 based on multiple new digital certificates, according to embodiments. Steps of method 500 that are the same or similar to steps of method 300 of FIG. 3 include the same reference numbers and will not be explained again. Method 500 may be performed by client host 110 when client host 110 is behind by multiple digital certificates, i.e., when server host 140 has updated its digital certificate multiple times since a digital certificate possessed by client host 110. For example, client host 110 may initiate method 500 upon encountering an exception in performing a handshake with server host 140, as discussed above in conjunction with FIG. 3.

At step 502, client host 110 transmits a certificate renewal request to server host 140, e.g., as an HTTP request or as an HTTPS request with digital certificate verification of server host 140 disabled. Client host 110 then receives, from server host 140 a certificate renewal response including all of certificate renewal packages 146, e.g., as an HTTP response or an HTTPS response. For example, the certificate renewal response may include certificate renewal packages 146 in an array, which is a data structure that stores a fixed-size sequence of elements in contiguous locations. For example, the array may be ordered from oldest to newest, i.e., from certificate renewal package 146 storing an oldest digital certificate issued to server host 140, to certificate renewal package 146 storing a newest digital certificate issued to server host 140. As mentioned previously, client host 110 may receive the certificate renewal response without verifying the identity of server host 140.

At step 504, client host 110 extracts one of certificate renewal packages 146 from the certificate renewal response, including, e.g., a headers field with an algorithm ID and key ID, a digital certificate field including a next digital certificate, and a digital signature field including a digital signature. For example, if certificate renewal packages 146 are ordered in an array such as from oldest to newest, client host 110 may extract one of certificate renewal packages 146 according to the order of the array, e.g., first selecting the first one of certificate renewal packages 146 in the array. At step 506, client host 110 attempts to locate, in trust store 120, a corresponding old digital certificate, which was issued to server host 140 but is no longer used by server host 140 for proving its identity. For example, client host 110 may attempt to locate the old digital certificate by attempting to match the key ID to a key ID in trust store 120.

At step 508, if client host 110 was unable to locate the corresponding old digital certificate, method 500 returns to step 504. Client host 110 performs 504-508 repeatedly until client host 110 is able to locate an old digital certificate corresponding to an extracted certificate renewal package. For example, the old digital certificate in trust store 120 may correspond to a second-oldest one of certificate renewal packages 146 from the certificate renewal response. In such case, client host 110 may perform steps 504-508 once for an oldest one of certificate renewal packages 146, then perform steps 504-508 again for the second-oldest one of certificate renewal packages 146. Once client host 110 locates a corresponding old digital certificate, method 500 moves to step 510.

At step 510, client host 110 decrypts the digital signature extracted from the certificate renewal response. Client host 110 decrypts the digital signature using the old public key from the old digital certificate located at step 506. To decrypt the digital signature, client host 110 may apply a verification algorithm corresponding to a signing algorithm identified by the headers field. Client host 110 then verifies that the next digital certificate was received from server host 140 based on the decrypted digital signature. For example, as discussed above, depending on the signing algorithm, client host 110 may hash certificate renewal package 146 and compare the result to the decrypted digital signature to determine if the result matches the decrypted digital signature. As another example, as discussed above, client host 110 may simply compare certificate renewal package 146 to the decrypted digital signature.

At step 512, if the verification was successful, method 500 moves to step 514. At step 514, client host 110 stores the next digital certificate in trust store 120, and client host 110 may also delete the previous digital certificate from trust store 120. Client host 110 then checks if there is another one of certificate renewal packages 146 in the certificate renewal response left to process, i.e., one for which steps 504-508 have not yet been performed. At step 516, if there is another one of certificate renewal packages 146 in the certificate renewal response to process, method 500 returns to step 504.

Client host 110 then repeats the above steps based on a next one of certificate renewal packages 146. In other words, client host 110 performs the above steps using one of certificate renewal packages 146 that includes a next digital certificate issued to server host 140 after the digital certificate that client host 110 just stored in trust store 120. For example, at the next iteration of step 504, client host 110 may extract the next one of certificate renewal packages 146 in an array that is ordered from oldest to newest to move chronologically to the next one of certificate renewal packages 146. Client host 110 may perform the above steps any number of times to extract and process each of certificate renewal packages 146 from the certificate renewal response.

Returning to step 516, once there are no more of certificate renewal packages 146 in the certificate renewal response to process, method 500 moves to step 318, client host 110 establishes the secure channel and exchanges data with server host 140 over the secure channel, and method 500 ends. Returning to step 512, if the verification is not successful, method 500 moves to step 320, client host 110 returns an error message, and method 500 ends. It should be noted that other sequences of steps besides those illustrated in FIG. 5 are envisioned for client host 110 to reestablish certificate-based trust based on multiple new digital certificates. For example, although FIG. 5 only illustrates transmitting one certificate renewal request at step 502, client host 110 may transmit a plurality of certificate renewal requests to server host 140, e.g., one certificate renewal request for each of certificate renewal packages 146. Client host 110 may then receive certificate renewal packages 146 one at a time, one in response to each certificate renewal request.

It should also be noted that after method 500, if client host 110 successfully established the secure channel with server host 140, future handshake requests with server host 140 will succeed as long as server host 140 continues using the same digital certificate for identifying itself. It should also be noted that in certain situations that are not illustrated in FIG. 5, client host 110 may not be able to reestablish certificate-based trust based on those of certificate renewal packages 146 included in the certificate renewal response. For example, client host 110 may not possess an old digital certificate corresponding to any of certificate renewal packages 146 included in the certificate renewal response. In such case, client host 110 returns an error message indicating that reestablishment of certificate-based trust could not be completed.

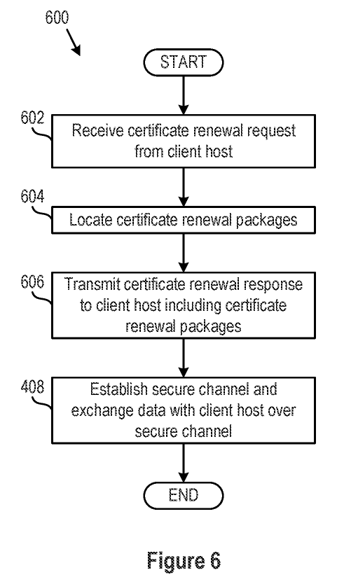

FIG. 6 is a flow diagram of a method 600 that may be performed by server host 140 to reestablish certificate-based trust with client host 110 based on multiple new digital certificates, according to embodiments. Steps of method 600 that are the same or similar to steps of method 400 of FIG. 4 include the same reference numbers and will not be explained again. Method 600 may be performed by server host 140 when client host 110 is behind by multiple digital certificates. At step 602, server host 140 receives a certificate renewal request from client host 110. According to method 600, the certificate renewal request may request server host 140 to provide all of certificate renewal packages 146 for reestablishing certificate-based trust.

At step 604, server host 140 locates a plurality of certificate renewal packages 146, e.g., all of them stored by server host 140. At step 606, server host 140 transmits a certificate renewal response to client host 110 including the located ones of certificate renewal packages 146, e.g., in an array ordered from oldest to newest. At step 408, assuming that client host 110 has successfully verified that the newest digital certificate was received from server host 140, server host 140 establishes the secure channel with client host 110, e.g., according to the TLS protocol. Server host 140 then exchanges data with client host 110 over the secure channel, and method 600 ends.

It should be noted that other sequences of steps besides those illustrated in FIG. 6 are envisioned for server host 140 to reestablish certificate-based trust based on multiple new digital certificates. For example, although FIG. 6 only illustrates one sequence of steps 602-606, server host 140 may receive a plurality of certificate renewal requests from client host 110. Server host 140 may then transmit one of certificate renewal packages 146 at a time, e.g., from oldest to newest.

The embodiments described herein may employ various computer-implemented operations involving data stored in computer systems. For example, these operations may require physical manipulation of physical quantities. Usually, though not necessarily, these quantities are electrical or magnetic signals that can be stored, transferred, combined, compared, or otherwise manipulated. Such manipulations are often referred to in terms such as producing, identifying, determining, or comparing. Any operations described herein that form part of one or more embodiments may be useful machine operations.

The embodiments described herein also relate to an apparatus for performing these operations. The apparatus may be specially constructed for required purposes, or the apparatus may be a general-purpose computer selectively activated or configured by a computer program stored in the computer. The embodiments described herein may also be practiced with computer system configurations including mobile computing devices, personal computers, server computers, microprocessor systems, mainframe computers, etc., and combinations thereof, which may communicate across one or more networks.

The embodiments described herein also relate to one or more computer programs or as one or more computer program modules embodied in computer-readable storage media. The term computer-readable medium refers to any data storage device that can store data, which can thereafter be input into an apparatus or computer system. Computer-readable media may be based on any existing or subsequently developed technology that embodies computer programs in a manner that enables a computer to read the programs. Examples of computer-readable media include magnetic drives, SSDs, network-attached storage (NAS) systems, RAM, read-only memory (ROM), compact disks (CDs), digital versatile disks (DVDs), and other optical and non-optical data storage devices. A computer-readable medium can also be distributed over a network-coupled computer system so that computer-readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and steps do not imply any particular order of operation unless explicitly stated in the claims.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components may be implemented as a combined component. Similarly, structures and functionalities presented as a single component may be implemented as separate components. These and other variations, additions, and improvements may fall within the scope of the appended claims.

What is claimed is:

1. A client host including a processor and memory, wherein the processor executes instructions stored in the memory to reestablish certificate-based trust between the client host and a server host, by performing the following steps:
transmitting, to the server host, at least one certificate renewal request, and then receiving, from the server host, at least one certificate renewal response including a new digital certificate issued to the server host and a first digital signature;
locating, in a trust store in the client host, a first old digital certificate that was issued to the server host before the new digital certificate but that is no longer used by the server host for proving the server host’s identity, and decrypting the first digital signature using a first old public key in the first old digital certificate;
verifying that the new digital certificate was received from the server host based on the decrypted first digital signature; and
in response to verifying that the new digital certificate was received from the server host:
storing the new digital certificate in the trust store; and
establishing a secure channel with the server host and exchanging data with the server host over the secure channel.

2. The client host of claim 1, wherein the steps further include:
transmitting a handshake request to the server host before transmitting the at least one certificate renewal request, and then receiving, from the server host, a handshake response including an unidentified digital certificate; and
determining that the unidentified digital certificate is not stored in the trust store, the client host transmitting the at least one certificate renewal request in response to the unidentified digital certificate not being stored in the trust store.

3. The client host of claim 1, wherein the steps further include:
extracting a token or data structure from the at least one certificate renewal response, the token or data structure including the new digital certificate and the first digital signature; and
verifying that the new digital certificate was received from the server host by either comparing the decrypted first digital signature to other contents of the token or data structure or comparing the decrypted first digital signature to a hash of the other contents of the token or data structure.

4. The client host of claim 1, wherein the at least one certificate renewal response further includes the first old digital certificate and a second digital signature, and the steps further include:
locating, in the trust store before locating the first old digital certificate, a second old digital certificate that was issued to the server host before the first old digital certificate but that is no longer used by the server host for proving the server host’s identity, and decrypting the second digital signature using a second old public key in the second old digital certificate;
verifying that the first old digital certificate in the at least one certificate renewal response was received from the server host based on the decrypted second digital signature; and
in response to verifying that the first old digital certificate in the at least one certificate renewal response was received from the server host, storing the first old digital certificate in the trust store.

5. The client host of claim 4, wherein the steps further include:
extracting a first token or data structure from an array in the at least one certificate renewal response, the first token or data structure including the first old digital certificate and the second digital signature; and
extracting a second token or data structure from the array, the second token or data structure including the new digital certificate and the first digital signature, the second token or data structure being extracted from the array after the first token or data structure according to an order of the array.

6. The client host of claim 1, wherein locating the first old digital certificate in the trust store includes:
extracting a key identifier (ID) from the at least one certificate renewal response; and
matching the extracted key ID to a key ID in the trust store.

7. The client host of claim 1, wherein the steps further include:
generating and transmitting the at least one certificate renewal request as a hypertext transfer protocol secure (HTTPS) request with digital certificate verification of the server host disabled, and then receiving the at least one certificate renewal response as an HTTPS response without verifying the server host’s identity.

8. A method of reestablishing certificate-based trust between a client host and a server host, the method comprising:
transmitting, to the server host, at least one certificate renewal request, and then receiving, from the server host, at least one certificate renewal response including a new digital certificate issued to the server host and a first digital signature;
locating, in a trust store in the client host, a first old digital certificate that was issued to the server host before the new digital certificate but that is no longer used by the server host for proving the server host’s identity, and decrypting the first digital signature using a first old public key in the first old digital certificate;
verifying that the new digital certificate was received from the server host based on the decrypted first digital signature; and
in response to verifying that the new digital certificate was received from the server host:
storing the new digital certificate in the trust store; and
establishing a secure channel with the server host and exchanging data with the server host over the secure channel.

9. The method of claim 8, further comprising:
transmitting a handshake request to the server host before transmitting the at least one certificate renewal request, and then receiving, from the server host, a handshake response including an unidentified digital certificate; and
determining that the unidentified digital certificate is not stored in the trust store, wherein the client host transmits the at least one certificate renewal request in response to the unidentified digital certificate not being stored in the trust store.

10. The method of claim 8, further comprising:
extracting a token or data structure from the at least one certificate renewal response, wherein the token or data structure includes the new digital certificate and the first digital signature; and
verifying that the new digital certificate was received from the server host by either comparing the decrypted first digital signature to other contents of the token or data structure or comparing the decrypted first digital signature to a hash of the other contents of the token or data structure.

11. The method of claim 8, wherein the at least one certificate renewal response further includes the first old digital certificate and a second digital signature, the method further comprising:
locating, in the trust store before locating the first old digital certificate, a second old digital certificate that was issued to the server host before the first old digital certificate but that is no longer used by the server host for proving the server host’s identity, and decrypting the second digital signature using a second old public key in the second old digital certificate;
verifying that the first old digital certificate in the at least one certificate renewal response was received from the server host based on the decrypted second digital signature; and
in response to verifying that the first old digital certificate in the at least one certificate renewal response was received from the server host, storing the first old digital certificate in the trust store.

12. The method of claim 11, further comprising:
extracting a first token or data structure from an array in the at least one certificate renewal response, wherein the first token or data structure includes the first old digital certificate and the second digital signature; and
extracting a second token or data structure from the array, wherein the second token or data structure includes the new digital certificate and the first digital signature, and the second token or data structure is extracted from the array after the first token or data structure according to an order of the array.

13. The method of claim 8, wherein locating the first old digital certificate in the trust store includes:
extracting a key identifier (ID) from the at least one certificate renewal response; and
matching the extracted key ID to a key ID in the trust store.

14. The method of claim 8, further comprising:
generating and transmitting the at least one certificate renewal request as a hypertext transfer protocol secure (HTTPS) request with digital certificate verification of the server host disabled, and then receiving the at least one certificate renewal response as an HTTPS response without verifying the server host’s identity.

15. A non-transitory, computer-readable medium comprising instructions that are executable in a client host, wherein the instructions when executed cause the client host to carry out a method of reestablishing certificate-based trust between the client host and a server host, and wherein the method comprises:
transmitting, to the server host, at least one certificate renewal request, and then receiving, from the server host, at least one certificate renewal response including a new digital certificate issued to the server host and a first digital signature;
locating, in a trust store in the client host, a first old digital certificate that was issued to the server host before the new digital certificate but that is no longer used by the server host for proving the server host’s identity, and decrypting the first digital signature using a first old public key in the first old digital certificate;
verifying that the new digital certificate was received from the server host based on the decrypted first digital signature; and
in response to verifying that the new digital certificate was received from the server host:
storing the new digital certificate in the trust store; and
establishing a secure channel with the server host and exchanging data with the server host over the secure channel.

16. The non-transitory, computer-readable medium of claim 15, wherein the method further comprises:
transmitting a handshake request to the server host before transmitting the at least one certificate renewal request, and then receiving, from the server host, a handshake response including an unidentified digital certificate; and
determining that the unidentified digital certificate is not stored in the trust store, the client host transmitting the at least one certificate renewal request in response to the unidentified digital certificate not being stored in the trust store.

17. The non-transitory, computer-readable medium of claim 15, wherein the method further comprises:
extracting a token or data structure from the at least one certificate renewal response, the token or data structure including the new digital certificate and the first digital signature; and
verifying that the new digital certificate was received from the server host by either comparing the decrypted first digital signature to other contents of the token or data structure or comparing the decrypted first digital signature to a hash of the other contents of the token or data structure.

18. The non-transitory, computer-readable medium of claim 15, wherein the at least one certificate renewal response further includes the first old digital certificate and a second digital signature, and the method further comprises:
locating, in the trust store before locating the first old digital certificate, a second old digital certificate that was issued to the server host before the first old digital certificate but that is no longer used by the server host for proving the server host’s identity, and decrypting the second digital signature using a second old public key in the second old digital certificate;
verifying that the first old digital certificate in the at least one certificate renewal response was received from the server host based on the decrypted second digital signature; and
in response to verifying that the first old digital certificate in the at least one certificate renewal response was received from the server host, storing the first old digital certificate in the trust store.

19. The non-transitory, computer-readable medium of claim 18, wherein the method further comprises:
extracting a first token or data structure from an array in the at least one certificate renewal response, the first token or data structure including the first old digital certificate and the second digital signature; and
extracting a second token or data structure from the array, the second token or data structure including the new digital certificate and the first digital signature, the second token or data structure being extracted from the array after the first token or data structure according to an order of the array.

20. The non-transitory, computer-readable medium of claim 15, wherein locating the first old digital certificate in the trust store includes:
extracting a key identifier (ID) from the at least one certificate renewal response; and
matching the extracted key ID to a key ID in the trust store.
